(19) United States
(12) Patent Application Publication
(10) Pub. No.: US 2009/0101639 A1
(43) Pub. Date: Apr. 23, 2009

(54) MICROWAVE HEATING METHOD AND DEVICE

(75) Inventors: Nils Kongmark, Ferney Voltaire (FR); Laurent Selles, Annecy Le Vieux (FR)

Correspondence Address: WILLIAM H. EILBERG, 316 CALIFORNIA AVE. #785, RENO, NV, 89509, US

(73) Assignee: CREATIVE HEATING SERVICES SA, Gland (CH)

(21) Appl. No.: 12/282,683

(22) PCT Filed: Mar. 13, 2007
(86) PCT No.: PCT/IB2007/000597

§ 371 Date: Sep. 12, 2008

(30) Foreign Application Priority Data
Mar. 13, 2006 (FR) 06 50846

(51) Int. Cl. H05B 6/80

(52) U.S. Cl. 219/725

(57) ABSTRACT

Monomode electromagnetic radiation is generated in an irradiation zone. A disc-shaped product to be treated is held vertically in a carriage and is moved translationally into the irradiation zone. Upstream, infrared lights subject the product to infrared radiation. Thus, the product is very rapidly defrosted.

### TECHNICAL FIELD OF THE INVENTION

The present invention relates to methods and devices making it possible to heat products with microwaves, that is to say by irradiating the products with an electromagnetic wave whose frequency is appropriate for agitating certain molecules contained in the product.

Since its discovery in 1946, the microwave cooking method has undergone considerable developments, and nowadays finds very frequent applications, especially in the thermal processing of foods. Microwave ovens generally form part of the equipment of private and professional kitchens.

In a traditional microwave oven, the foods are placed in a cooking enclosure. Electromagnetic waves are generated by a magnetron and are brought into the cooking enclosure by a waveguide. The magnetron generally comprises a cylindrical anode composed of resonant cavities, and a heating cathode which releases electrons into the evacuated interaction space which lies between the cathode and the anode. Magnets accelerate the electrons in the interaction space, and a continuous electric field is applied between the anode and the cathode. The movement of the electrons around the cathode generates electromagnetic oscillations in the resonant cavities. Part of the electromagnetic waves thus generated is tapped off by the waveguide, which conducts them to the cooking enclosure. The dimensions of the cavities of the anode are chosen in such a way that the electromagnetic waves emitted have a frequency of 2450 MHz.

Water molecules, which are dipolar in nature, that is to say with a barycenter of the negative charges that is different from the barycenter of the positive charges, have a tendency to orient themselves by following the electric field making up the electromagnetic waves present in the cooking cavity. On account of the alternating nature of these electromagnetic waves, the water molecules are thus successively oriented in one sense then in the other at the speed of variation of the electromagnetic wave, that is to say by oscillating 4 billion 900 million times per second.

In this generally used principle, the electromagnetic waves generated by a magnetron traverse the entire cooking enclosure by reflecting off the walls of the enclosure, and penetrate in a random manner into the products placed inside the cooking enclosure. So-called “multimode” electromagnetic waves are thus involved.

When an electromagnetic wave reaches the surface of a dielectric product placed in the cooking enclosure, part of the wave is reflected, and part of the wave penetrates into the product and is absorbed, being transformed into heat by agitation of the dipolar water molecules of the product. The power P absorbed in the product depends on the intensity of the electric field E to which the product is subjected, its frequency f, and the dielectric loss factor ∈″ characteristic of the material constituting the product, according to the approximate formula:

P=5·56·10⁻⁴·f·∈″·E²

During thermal processing, a difficulty is the heterogeneous character of the product irradiated by the microwaves: certain zones of the product may exhibit a greater dielectric loss factor than other zones of the product, as a function of various parameters such as the nature of the product, its temperature, its frozen or defrosted physical state.

It follows from this that the product zones with a large dielectric loss factor heat up more quickly, producing overheated zones, while other zones remain cold.

One generally attempts to reduce the drawbacks of such a heterogeneity by organizing multiple reflections of the electromagnetic waves off the walls of the cooking cavity, and by moving the product on a turntable.

Another difficulty results from the reflection of the electromagnetic waves, which do not penetrate into the product and do not ensure any heating, while being redirected towards other zones of the cooking enclosure and optionally towards the magnetron, so risking destroying it.

In the case of products that one wishes to defrost, an additional difficulty results from the very low dielectric loss factor of water in the solid state, thus making it necessary to provide longer defrosting cycles in which periods of irradiation by microwaves and waiting periods without irradiation are alternated to attempt to avoid the appearance of a very significant heterogeneity between already defrosted zones and still frozen zones of one and the same product.

As a result of these phenomena, thermal processing by microwaves is relatively slow.

Document WO 82/00403 is aimed at accelerating the defrosting by microwaves of frozen animal quarters, by virtue of the application of a cold air current to the surface of the animal quarters, the cold air ensuring the cooling of the surface of the animal quarters and consequently favoring the penetration of the microwaves into the product. The microwaves used are of the multimode type, in an enclosure having a high-reflectivity wall. The animal quarters are moved within the enclosure, and can rotate to receive the microwaves from several directions.

Such a method remains slow, since the penetration of the microwaves remains superficial and random.

A monomode microwave technique, such as described in particular in document U.S. Pat. No. 4,775,770, making it possible to increase the penetration of electromagnetic waves into a product has recently been developed. The method, in this document, is applied to the heating of objects such as hermetically packaged liquids subjected to an external overpressure. Two wave trains of opposite senses are directed either side of the product so as to be superimposed in the product, forming a cumulative field. The two wave trains of opposite senses can be achieved through a single emitter whose energy is split into two opposite directions and directed by semi-torus waveguides, or through two emitters of substantially identical frequencies and amplitudes and of like polarization which each generate one of the two wave trains directed towards the product. The application of the microwaves to the product can be done in a stationary manner, if the product is of lesser size than that of the zone receiving the microwaves. In the case of a product of larger size, it can be displaced in the irradiation zone, by scanning.

However, the speed of thermal processing by such a device remains insufficient, especially in the case of frozen products, and there is a significant risk of destroying the magnetrons because of the reflection of the electromagnetic waves. It is noted that about 120 seconds are required to bring a product such as a hamburger, initially frozen to −18° C., to a temperature of about 80° C. in a relatively homogeneous manner. Cooking additionally requires further time.

As an alternative, and in a more traditional manner, foods are generally heated by being placed in contact with a hot surface such as a hotplate, a frying pan, a saucepan, or through infrared radiation by embers or electric resistors. These heating techniques can be fast, but act essentially from the surface of the product, and thus cause more intense heating of the surface. The core of the product receives thermal energy by conduction from the surface, and therefore receives less intense heating. This again results in a limit in the speed of thermal processing if one wishes to avoid too great a heterogeneity of processing between the surface of the product and the core of the product.

And this heterogeneity is further amplified in the case of a product initially in the frozen state. For example, the thermal processing of hamburgers, to pass from the frozen state to the cooked state ready for consumption, requires about 122 seconds with the current techniques used, for example in fast-food catering. And this thermal processing requires the intervention of a labor force for relatively numerous manipulations that cannot be automated at the present time.

### SUMMARY OF THE INVENTION

The problem proposed by the present invention is to substantially increase the speed of the thermal processing of products such as foods, especially foods which are initially in the frozen state, so as to bring them to a defrosted state suitable for consumption.

The invention is also aimed at allowing the automation of the thermal processing.

There is also a benefit, in this thermal processing, in preserving to the maximum the initial weight of the product (water, fats), in reducing global energy consumption for this thermal processing, in reducing pollution of the environment, and in preserving the properties of the food.

The objective is for example to cook a hamburger initially frozen to −18° C., defrosting and cooking being carried out in less than a minute.

The invention results from the idea consisting in using the abrupt and high variation in the dielectric loss factor of water on passing from its solid state to its liquid state. The dielectric loss factor of frozen pure water is 0.003. Typical frozen products have a water content which can vary from 0% to 95%. It is therefore possible for their dielectric loss factor in the frozen state to vary considerably. Frozen food products may thus in general have a dielectric loss factor ranging from 0.1 to 1.8, depending on the presence of salts, the nature of the dry matter, etc. In the defrosted state, the same food products have a dielectric loss factor which also varies, on average of the order of 14. Thus, on passing from the frozen state to the defrosted state, the dielectric loss factor of a food product passes from a value of the order of 1.6 in the frozen state to a value of the order of 14 in the defrosted state. According to the invention, the use of this phenomenon is organized by virtue of the application of monomode microwaves in a reduced product zone which itself moves in a manner which is appropriate in terms of direction and speed.

Thus, to achieve these aims as well as others, the invention proposes a microwave heating method for the defrosting and thermal processing of a frozen product, comprising at least one step a) of defrosting in the course of which a portion of the product is placed in an irradiation zone subjected to a monomode electromagnetic radiation with superposition of opposite wave trains and a relative displacement of the irradiation zone and of the product with respect to one another is carried out so that the irradiation zone traverses the whole of the frozen product and at a speed and along a direction such that the irradiated portion of product extends permanently, during said displacement, on either side of a boundary between an already defrosted zone of irradiated portion of product and a still frozen adjacent zone of irradiated portion of product.

In the course of this step a), said at least one irradiated portion of product contains a moving boundary situated at each instant between a defrosted zone of irradiated portion of product and a still frozen zone of irradiated portion of product. In the case of monomode radiation, the largest part of the radiation energy is concentrated along a relatively narrow and rectilinear zone, which is designated by the expression “irradiation zone”. The moving boundary takes the shape of the irradiation zone, and is generally rectilinear. The defrosted zone of irradiated portion of product exhibits a high dielectric loss factor, which thus concentrates the transformation of the electromagnetic waves into thermal energy, thereby locally raising the temperature of the product in the defrosted zone of irradiated portion of product. By thermal conduction, the heat present in the defrosted zone of irradiated portion of product propagates, across the boundary, into the still frozen adjacent zone of irradiated portion of product, causing its defrosting. The boundary thus tends to move naturally towards the still frozen part of the product, and moves away from the product part which previously constituted the defrosted zone of irradiated portion of product. According to the invention, the irradiation zone is displaced with respect to the product (or, what amounts to the same, the product is displaced with respect to the irradiation zone) by following, in terms of direction and speed, the natural displacement of the boundary. Thus the energy of the electromagnetic waves is used to heat only the defrosted zone adjacent to the boundary, and therefore serves, by thermal conduction along a short path, to rapidly defrost the frozen zone adjacent to the boundary.

The defrosting of the product is thus very substantially accelerated by combining significant absorption of the electromagnetic waves in the defrosted zone of irradiated portion of product and fast thermal conduction towards the still frozen adjacent zone of irradiated portion of product.

The extent of the defrosted zone of irradiated portion of product is limited to the zone immediately adjacent to the boundary with the frozen zone of irradiated portion of product, this being made possible by virtue of the monomode electromagnetic radiation whose energy is concentrated on a narrow product zone on either side of the boundary between the defrosted part and the still frozen part. This avoids having to unnecessarily heat the defrosted zones further away from the boundary, which zones would not have any appreciable effect of conducting heat towards the still frozen zones.

To bring the product to a temperature of markedly greater than 0° C., there is furthermore provided a subsequent step b) of heating the already defrosted product, in the course of which the product is irradiated by a monomode electromagnetic radiation by placing an irradiated portion of the product in an irradiation zone and by carrying out a relative displacement of the irradiation zone and of the product with respect to one another in such a way that the irradiation zone traverses the whole of the product, until it brings the product to a determined temperature.

The defrosting operation and the operation of heating beyond 0° C. are thus separated. In this way, in the course of the subsequent heating operation, the product to be processed does not include any still frozen zone liable to constitute a zone with a lower capacity to absorb the energy of the electromagnetic waves. The homogeneity of heating is thus improved.

Preferably, the irradiation zone exhibits an elongate form along a direction of elongation, defining a boundary line between the defrosted zone and the still frozen adjacent product zone. The relative displacement of the irradiation zone and of the product is performed transversely with respect to the direction of elongation. The electromagnetic radiation propagates, in the irradiation zone, along a direction of propagation substantially perpendicular to the direction of elongation and to the direction of the relative displacement.

Preferably, to produce defrosting in a single pass of the product, it is provided that:
the irradiation zone exhibits, along the direction of elongation, a length substantially equal to a first corresponding dimension of the product to be processed,
the irradiation zone exhibits, along the direction of displacement, a width that is less than its length and markedly less than the dimension of the product to be processed in this same direction of displacement.

According to an advantageous embodiment, during the relative displacement of the irradiation zone and of the product, the irradiation zone is fixed and the product is moving.

The faces of the product receiving the electromagnetic waves are generally subjected to an additional heating, which may cause a flow of liquids or of fats. To discharge this flow, it is advantageous that the direction of elongation of the irradiation zone be contained in a substantially vertical plane. The liquids and the fats discharged, gathered clear of the product, thus do not disturb heating of the product itself by the electromagnetic radiation.

The problems of the reflection of electromagnetic waves towards the magnetron can be solved by making provision that, during the relative displacement of the irradiation zone and of the product, the electromagnetic power injected is adapted to the size and to the dielectric properties of the irradiated portion of the product to be processed, so as to permanently ensure, in the irradiated portion, regulation of the volumic power, advantageously at a level substantially equal to or not very different from the volumic power absorbable by the irradiated portion of the product.

For this purpose, the regulation of the volumic power can be performed by varying the speed of relative displacement between the irradiation zone and the product and/or by varying the global electromagnetic power injected.

According to another aspect, the invention makes provision to apply the above method to the processing of products having to be defrosted, cooked and grilled at the surface. For this purpose provision may advantageously be made for, prior to the defrosting step a), the product to be exposed to at least one infrared radiation.

This prior processing by infrared radiation, when it is applied to products such as meat products, by heating their surface to more than about 208° C., produces a crust which constitutes at one and the same time an esthetic element through its browning, and a protective element which encloses the core of the product and subsequently prevents it from drying out during irradiation by the microwaves in the course of the heating step b).

Moreover, the surface zone thus processed by infrared constitutes a surface zone that is essentially transparent to microwaves, which further favors the core heating of the product by the microwaves.

Advantageously, the infrared radiation or radiations can be applied to the product in the neighborhood of the irradiation zone, resulting in an application of infrared by scanning following the relative displacement of the product.

To further increase the speed of thermal processing, the infrared radiation or radiations can be applied simultaneously to the whole of the surface of the product.

Preferably, prior to the defrosting step a), the product is exposed to a short-wave infrared radiation and to a long-wave infrared radiation. The short infrared waves dry a surface film of the product, while the long infrared waves act over a larger depth and thus increase the heating of the surface zone of the product.

Preferably, during exposure to the infrared radiation, an air current is generated so as to discharge the evaporated water and dry the product at the surface. This arrangement further improves the quality and effectiveness of the surface crust.

During the processing, it is preferable to maintain the product in shape and in position.

According to another aspect, the invention proposes a microwave heating device for implementing the above method, and comprising:
radiation generating means for generating in at least one irradiation zone a monomode electromagnetic radiation with wave trains propagating in opposite senses along a direction of propagation,
means for holding a product to be processed for placing at least one irradiated portion of a product in the irradiation zone,
displacement means for ensuring the relative displacement of the irradiation zone and of the product to be processed along a transverse direction of displacement with respect to the direction of propagation of the radiation, and at a speed appropriate for following the displacement of a boundary between defrosted zone and still frozen zone of the product to be processed.

In practice, provision may advantageously be made for the irradiation zone to preferably exhibit an elongate form along a direction of elongation, the displacement means to produce a relative displacement along a transverse direction of displacement with respect to the direction of elongation, and the radiation generating means to produce a monomode electromagnetic radiation with direction of propagation substantially perpendicular to the direction of elongation and to the direction of displacement.

According to an advantageous embodiment, the device comprises means for regulating the volumic power injected into the product, so as preferably to inject a volumic power permanently substantially equal to or not very different from the volumic power absorbable by the product. Electromagnetic waves are thus prevented from returning towards the electromagnetic wave generator.

For example, the means for regulating the volumic power injected can comprise means for controlling the global electromagnetic power and/or the speed of displacement of the product to be processed with respect to the irradiation zone, so as to permanently adapt the global electromagnetic power and/or the speed as a function of the volume and dielectric properties of the irradiated portion of the product.

Preferably, the device furthermore comprises means for generating an infrared radiation for applying an infrared radiation to the surface of the product upstream of the irradiation zone or zones.

Preferably, the infrared radiation generating means can be designed to apply an infrared radiation simultaneously to the whole of the surface of the product, with preferably means for sucking in and/or circulating air for drying the surface of the product exposed to the infrared radiation.

### BRIEF DESCRIPTION OF THE DRAWINGS

Other objects, characteristics and advantages of the present invention will emerge from the following description of particular embodiments, given in conjunction with the appended figures, among which:

FIG. 1 illustrates the variation of the dielectric loss factor as a function of temperature, for distilled water and for a few other customary foods;

FIG. 2 is a perspective view of a microwave heating device according to an embodiment of the present invention;

FIG. 3 is a section through the perspective view of FIG. 2, taken diagonally along the plane I-I;

FIGS. 4 to 7 illustrate four successive steps of the operation of the device of FIGS. 2 and 3, in the course of a microwave heating method according to an embodiment of the invention;

FIG. 8 illustrates in perspective the defrosting method according to the invention, applied to a disk-shaped product; and

FIGS. 9 to 13 illustrate 5 steps of said defrosting method.

### DESCRIPTION OF THE PREFERRED EMBODIMENTS

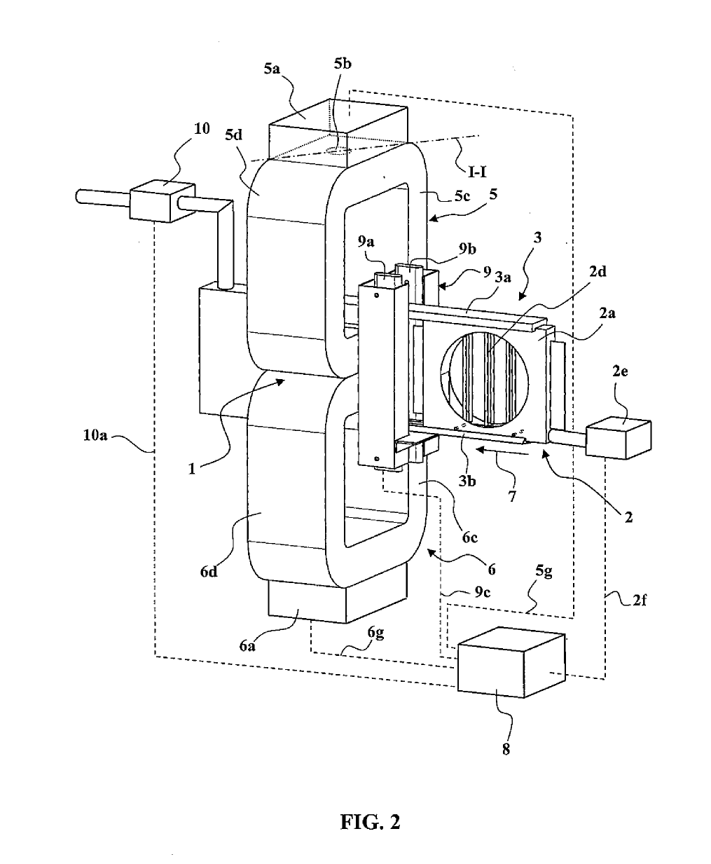

In the embodiment illustrated in FIGS. 2 to 7, the microwave heating device according to the present invention comprises radiation means for generating a monomode electromagnetic radiation in an irradiation zone 1, means for holding products to be processed 2, and displacement means 3 for ensuring the relative displacement of the product to be processed and of the irradiation zone 1.

Thus, the device is adapted for processing a product 4.

In the example illustrated, the product 4 has the shape of a disk (FIG. 8), that will be held in a vertical displacement plane, so as to apply to it a monomode electromagnetic radiation in the irradiation zone 1 where the radiation propagates in the direction of the thickness “e” of the product 4.

The radiation means for generating the monomode electromagnetic radiation comprise a first generator assembly 5 and a second generator assembly 6, each adapted for generating a monomode electromagnetic radiation in a respective half of the irradiation zone 1: the first generator assembly 5 produces a monomode electromagnetic radiation in the first half 1a of the irradiation zone 1, while the second generator assembly 6 produces a monomode electromagnetic radiation in the second half 1b of the irradiation zone 1.

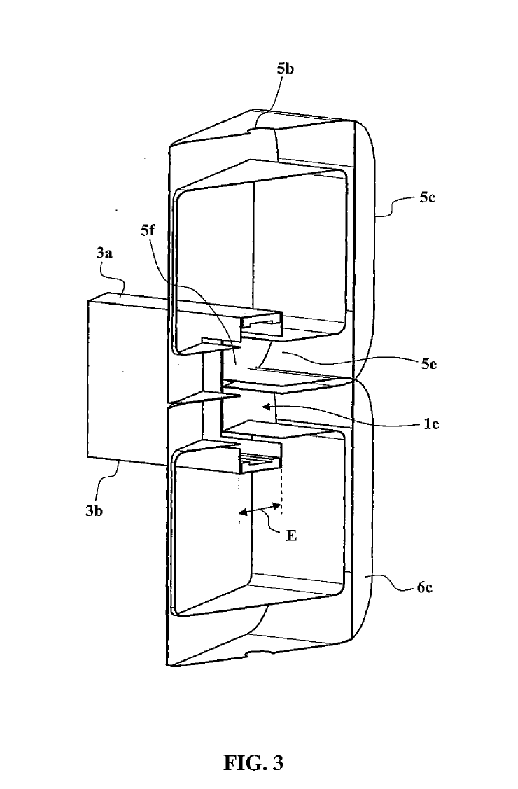

The first generator assembly 5 comprises a magnetron 5a which introduces through an orifice 5b an electromagnetic wave in two opposite half-ring waveguides 5c and 5d with rectangular cross section, arranged symmetrically to one another on either side of the vertical displacement plane. The waveguides 5c and 5d each exhibit a mid-plane of vertical symmetry perpendicular to the vertical displacement plane. The waveguides 5c and 5d conduct the electromagnetic waves to a convergence volume 1c which contains the corresponding irradiation zone part 1a and which itself exhibits a parallelepipedal shape situated between the two respective rectangular exit orifices 5e and 5f (FIG. 3) of the waveguides 5c and 5d. The thickness E of the irradiation zone 1, or distance between the exit orifices 5e and 5f, is not much greater than the thickness of the product 4 that one desires to process. In the convergence volume 1c, and in particular in the irradiation zone 1, two wave trains originating from the waveguides 5c and 5d are superimposed, being of opposite senses and directed towards one another along the direction of propagation linking the exit orifices 5e and 5f.

The second generator assembly 6 has the same structure as the first generator assembly 5, with a magnetron 6a and two opposite waveguides 6c and 6d.

By using two generator assemblies 5 and 6 it is possible to double the surface area of the irradiation zone 1, for example to process a product 4 having a greater diameter.

It will however be possible, without departing from the scope of the invention, to process products 4 of smaller dimensions by using a single generator assembly such as the assembly 5.

The means for generating monomode electromagnetic radiation can be of the type already described in document U.S. Pat. No. 4,775,770, which is cited here as reference. The waveguides 5c and 5d are devised, in a known manner, so as to favor the propagation of a single mode of radiation.

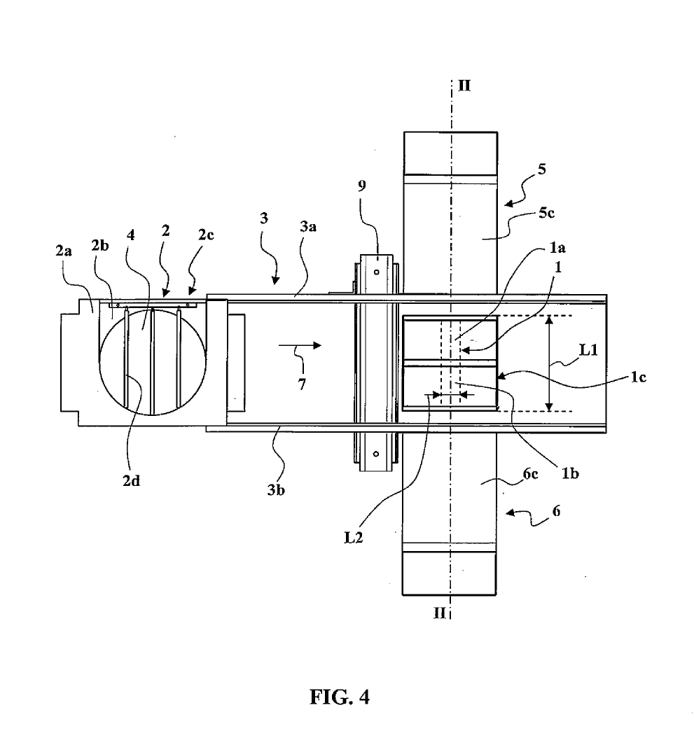

Such means for generating monomode electromagnetic radiation produce a radiation whose intensity is a maximum in the symmetry mid-plane of the waveguides (illustrated by the direction of elongation II-II in FIG. 4), and whose intensity decreases rapidly on either side of the symmetry mid-plane. Thus, the electromagnetic energy is concentrated essentially in the immediate neighborhood of the mid-plane, thereby defining the position and the width of the irradiation zone 1 illustrated dashed in FIG. 4. The irradiation zone 1 will be considered to be defined by the narrow portion of the convergence volume 1c which receives more than 60% of the energy of the monomode electromagnetic radiation.

The magnetrons advantageously work at a frequency lying between 2 and 3 GHz, preferably at a frequency of 2.45 GHz.

The means for holding products to be processed 2 comprise, in the embodiment illustrated, a carriage 2a in the form of a cradle, comprising a cavity 2b adapted to receive and contain a product 4 to be processed, with an upper opening 2c for introducing and withdrawing the product 4 to be processed and with two open lateral faces furnished with retaining rods 2d made of quartz, on either side of the product 4 to be processed. The carriage 2a can be made of metal, or any other appropriate material for supporting infrared radiation and microwave radiation.

The displacement means 3, intended to ensure the relative displacement of the irradiation zone 1 and of the product 4 to be processed, are adapted for guiding the carriage 2a and the product 4 to be processed that it contains by sliding along a direction of relative displacement illustrated by the arrow 7, so that the product 4 to be processed is made to travel past the irradiation zone 1. Thus, the displacement means 3 comprise upper guides 3a and lower guides 3b, and can comprise motorization means such as a ram 2e for displacing the carriage 2a along the guides 3a and 3b at an appropriate speed.

As seen in section in FIGS. 4 to 8, the irradiation zone 1 exhibits an elongate form along the direction of elongation II-II, in the mid-plane of the waveguides 5c, 5d, 6c, 6d of the generator assemblies 5 and 6, and the displacement means 3 produce a relative displacement along a direction of displacement 7 which is transverse with respect to the direction of elongation II-II.

As illustrated in the figures, the irradiation zone 1 exhibits, along the direction of elongation II-II, a length L1 substantially equal to the height of the product 4 to be processed.

The irradiation zone 1 exhibits, along the transverse direction which is in the mid-plane and perpendicular to the direction of displacement 7, a thickness E that is less than the thickness of the product 4 to be processed. This transverse direction of thickness E is also the direction of propagation of the electromagnetic waves in the irradiation zone 1.

By the fact that the electromagnetic wave is essentially concentrated in proximity to the symmetry mid-plane containing the direction of elongation II-II, the irradiation zone 1 exhibits, along the direction of displacement 7, a reduced width L2 that is markedly less than the dimension of the product 4 to be processed in the direction of displacement 7.

In the embodiment illustrated, the irradiation zone 1 is fixed, and the displacement means 3 displace the product 4 to be processed with respect to the irradiation zone 1 which is fixed. For this purpose, the carriage 2a is driven by a ram 2e itself driven by a control device 8.

The device illustrated furthermore comprises means for regulating the volumic power injected into the product to be processed. The reason is that the volumic power injected must, preferably, be substantially equal to the power that can be absorbed by the product in its actual physical state, so as to prevent the non-absorbed electromagnetic waves from passing through the product and returning to the magnetrons 5a and 6a, thus risking destroying them.

Thus, the control device 8 also drives the magnetrons 5a and 6a, to which it is linked by respective control lines 5g and 6g, and the control device 8 is linked to the ram 2e by a control line 2f. The control device 8 is adapted for regulating the volumic power in the product in such a way that it is permanently substantially equal to or not very different from the volumic power absorbable by the product.

According to a first procedure, the control device 8 controls the global electromagnetic power delivered by the magnetrons 5a and 6a so as to permanently adapt the global electromagnetic power as a function of the volume and of the dielectric properties of the irradiated portion of the product.

As an alternative or as a supplement, the control device 8 permanently adapts the speed of displacement of the carriage 2a by the ram 2e as a function of the product volume present in the irradiation zone 1: for a disk-shaped product 4 such as illustrated in FIG. 4, it is understood that the product volume grows from a zero volume when the product 4 is tangential to the irradiation zone 1 as the product starts penetration into the irradiation zone 1, then increases until it attains a maximum when a diameter of the product is present in the irradiation zone 1, then decreases until it vanishes when the product 4 again becomes tangential to the irradiation zone 1. In practice, the control device 8 can vary the speed of displacement of the carriage 2a, with a greater speed as the product starts penetration into the irradiation zone 1, then by decreasing the speed as and when a greater product volume is situated in the irradiation zone 1, then by progressively increasing the speed until the product finishes passing through the irradiation zone 1.

In the embodiment illustrated in the figures, the heating device according to the invention furthermore comprises means for generating an infrared radiation 9, for applying an infrared radiation to the surface of the product 4 upstream of the irradiation zone or zones 1, 1a and 1b. The infrared radiation generating means 9 are driven by the control means 8, to which they are linked by a control line 9c.

The infrared radiation can be applied to just a portion of the surface of the product 4, as represented in the figures, or can advantageously be applied simultaneously to the whole of the surface of the product 4.

In practice, the infrared radiation can be produced by infrared lamps 9a, 9b placed either side of the guides 3a and 3b, upstream of the irradiation zone 1 in the sense of displacement 7 of the carriage 2a, and in the neighborhood of the irradiation zone 1.

The infrared radiation lamps 9a and 9b can be strips arranged vertically, parallel to the main faces of the product 4 and perpendicular to the direction of displacement 7 of the carriage 2a.

The infrared radiation lamps 9a and 9b can successively comprise, in the direction of the displacement 7, first of all at least one shorter-wave infrared radiation lamp, then at least one longer-wave infrared radiation lamp.

During the thermal processing of the product 4, it is beneficial to dry the external surface of the product. Means for sucking in and/or circulating air 10, for example a suction turbine connected up to the zone occupied by the infrared radiation lamps 9a and 9b and connected up to the irradiation zone 1, are provided for this purpose. The suction means 10 are driven by the control means 8, to which they are linked by a control line 10a.

The carriage 2a can advantageously be made of stainless steel.

It can advantageously furthermore comprise elements such as quartz vertical rods 2d, which are transparent to the electromagnetic waves as they pass through the irradiation zone 1, and which help to maintain the product 4 in shape and in place in the course of its processing in the irradiation zone.

In the embodiment of FIGS. 4 to 7, comprising a prior surface heating by infrared, a bare product 4, devoid of any wrapping, is processed.

At the start of the operating cycle, illustrated in FIG. 4, the carriage 2a is clear of the irradiation zone 1, and can receive the product 4 to be processed through the upper opening 2c of the cavity 2b. The carriage 2a is then displaced in the direction of displacement 7 towards the irradiation zone 1.

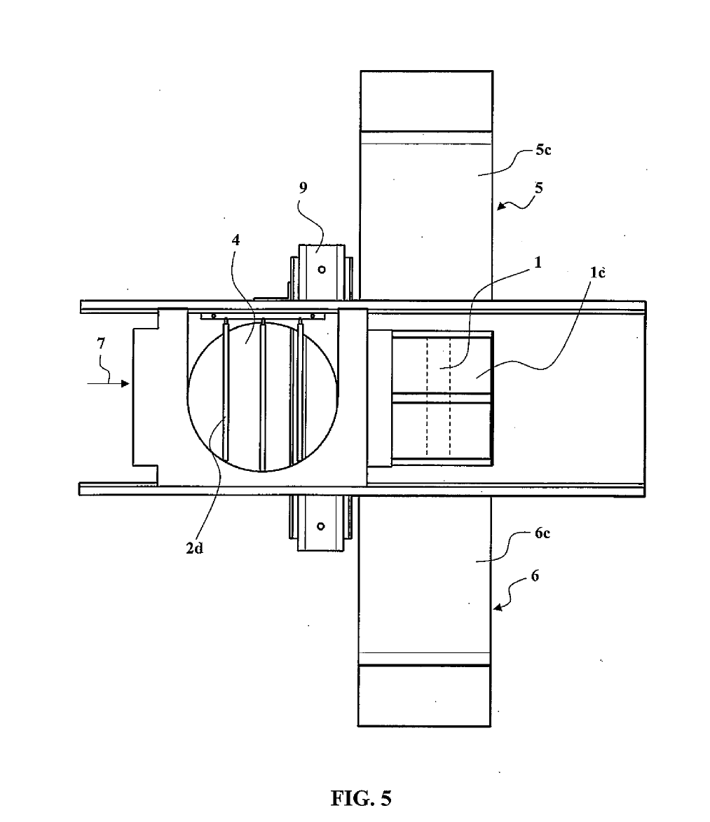

In FIG. 5, the product 4 to be processed passes in front of the means for generating an infrared radiation 9, which generate an infrared radiation applied to the main faces of the product 4.

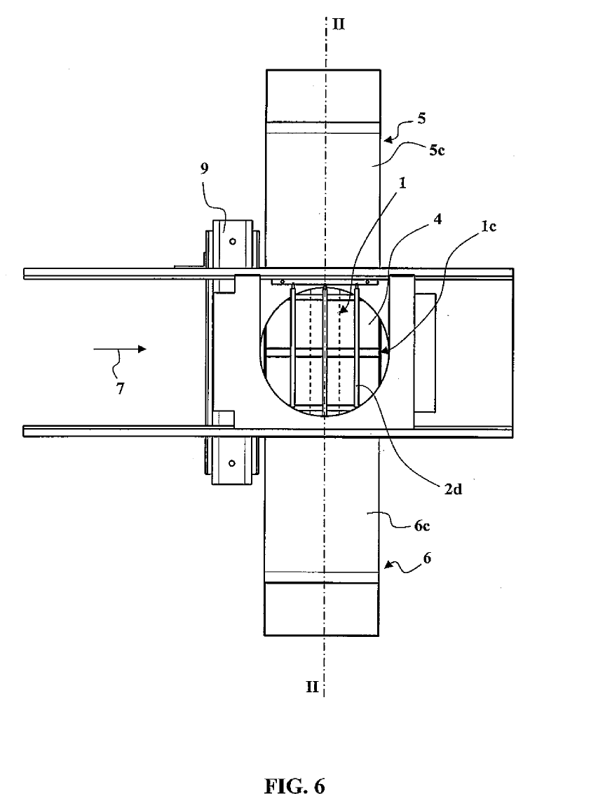

In FIG. 6, the product 4 to be processed travels past the irradiation zone 1, and is thus subjected to the electromagnetic waves producing its core heating.

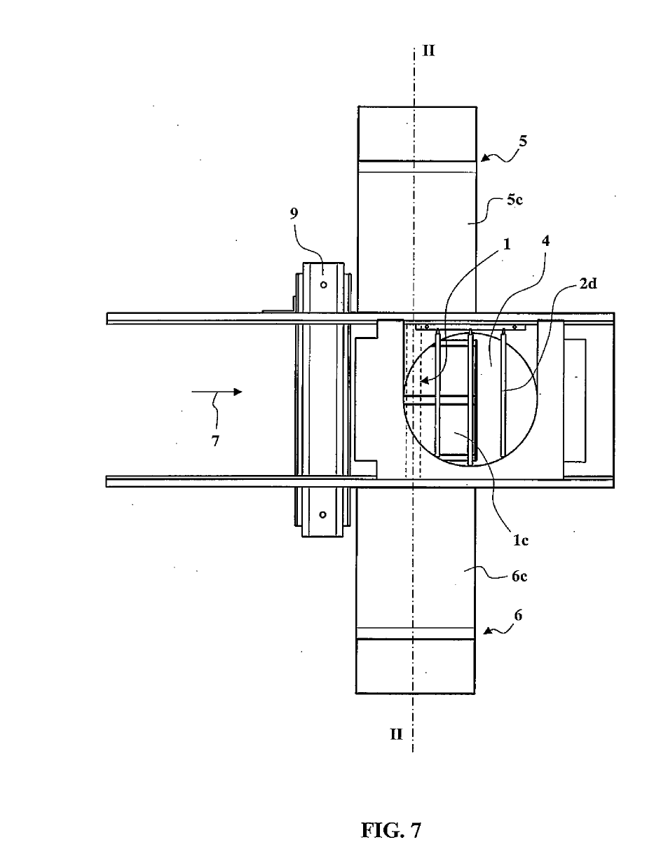

In FIG. 7, the product 4 to be processed finishes passing in front of the irradiation zone 1, and the defrosting step is thus terminated.

The movement illustrated in the successive FIGS. 4 to 7 constitutes a first step a) of defrosting, in the course of which the product 4 is partially irradiated by scanning with the monomode electromagnetic radiation generated in the irradiation zone 1. Just a portion of the product 4 is irradiated in the irradiation zone 1, and a relative displacement of the irradiation zone 1 and of the product 4 with respect to one another is carried out in such a way that the irradiated portion of product 4 permanently comprises at least one defrosted zone of irradiated portion of product and one frozen adjacent zone of irradiated portion of product.

After step a), that is to say when the defrosted product 4 is clear of the irradiation zone 1, as illustrated in FIG. 7, it is possible to undertake a subsequent step b) of heating, consisting in partially irradiating the product 4 by scanning with a monomode electromagnetic radiation, placing at least one irradiated portion of product in an irradiation zone such as the irradiation zone 1, and carrying out a relative displacement of the irradiation zone and of the product the one with respect, until the product is brought to a determined temperature.

For example, it is possible to displace the carriage 2a in the sense inverse to the arrow 7, so as to cause the product 4 to pass into the irradiation zone 1 initially used for defrosting.

The power delivered by the magnetrons during this second heating passage may be higher than the power delivered during the first defrosting passage.

The position is then as illustrated in FIG. 4, in which position the product 4 can be withdrawn from the carriage 2a.

It is understood that the operation of the device can be entirely automated, from the introduction of the product 4 as illustrated in FIG. 4, up to its withdrawal in this same position of FIG. 4.

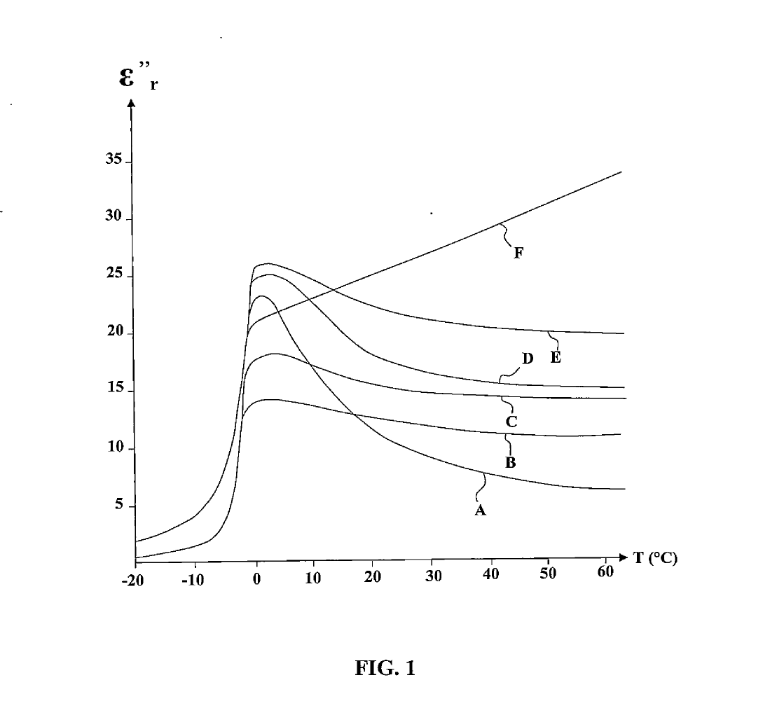

FIG. 1 is now considered, which illustrates the variation of the dielectric loss factor ∈″ of water and of a few food products as a function of temperature.

Curve A corresponds to pure water, curves B, C, D, E and F correspond respectively to cooked beef, to raw beef, to cooked carrots, to mashed potatoes and to cooked ham.

It is seen that in all cases the dielectric loss factor ∈″ is relatively low for negative temperatures, that it undergoes a very abrupt increase in the neighborhood of the temperature 0° C., and thereafter in most cases experiences a maximum and a progressive decay on heating beyond the temperature 0° C.

It follows from this that, in the frozen state, a product containing water, for example a food to be processed thermally, exhibits a very low dielectric loss factor. Consequently, electromagnetic waves applied to the product tend to be reflected or to pass through the product, and to return to the magnetrons.

On the other hand, when the product is defrosted, the larger dielectric loss factor allows a greater transformation of the electromagnetic energy into heat.

The invention exploits this phenomenon, by processing the product so as to permanently preserve, in the irradiation zone, at least one defrosted product portion which will concentrate the heating by the electromagnetic waves and transmit this heating by conduction towards the adjacent zone not yet defrosted.

Let us consider FIG. 8, which illustrates in perspective a disk-shaped product 4, undergoing defrosting processing in an irradiation zone 1.

The disk-shaped product 4 exhibits a thickness e and a diameter D. It is contained only in part in the irradiation zone 1 which itself has a parallelepipedal shape of height L1, length L2, and thickness E.

The thickness E of the irradiation zone is greater than the thickness e of the product 4. The height L1 of the irradiation zone is greater than the diameter D of the product 4. The length L2 of the irradiation zone is markedly less than the diameter D of the product 4.

Thus, the irradiation zone 1 exhibits an elongate shape along a direction of elongation II-II, vertical in FIG. 8.

In the irradiation zone 1, the product 4 exhibits, essentially along the direction of elongation II-II, a boundary F between a defrosted part 4a (illustrated with striations) and a still frozen part 4b (devoid of striations). This boundary F moves towards the still frozen part, as illustrated by the arrow V, at the speed of propagation of heat in the product 4. According to the invention, an intentional and controlled relative displacement V′ of the product 4 and of the irradiation zone 1 is ensured at the same speed and along the same direction as this natural displacement of the boundary F, so that the irradiated portion 4a, 4b of the product 4 extends permanently, during the displacement, on either side of the boundary F.

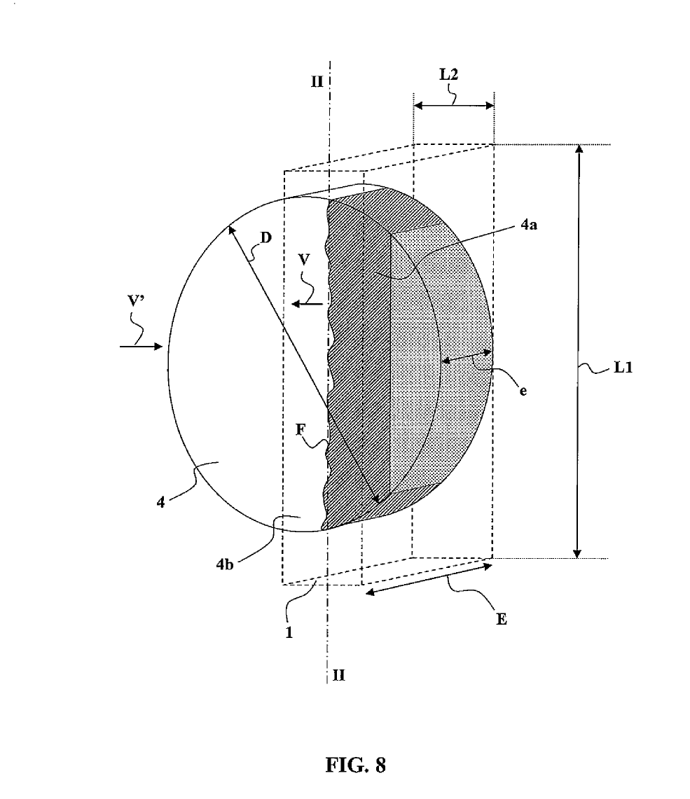

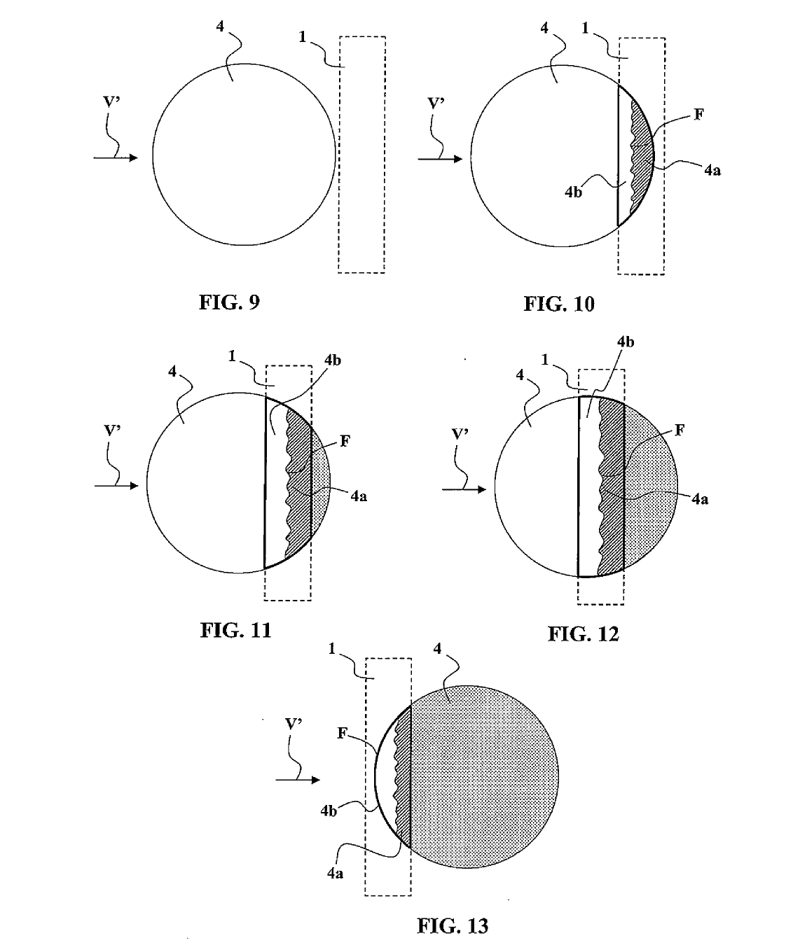

In FIG. 9, the product 4 is in the frozen state, entirely outside the irradiation zone 1. It is displaced in the sense illustrated by the arrow V′.

In FIG. 10, a portion of the product 4 has penetrated into the irradiation zone 1, and a boundary F is seen to appear between a defrosted zone 4a and a still frozen zone 4b, the zones 4a and 4b constituting the irradiated zone of the product 4. The boundary F has a tendency to move towards the left.

In FIG. 11, a relative displacement of the product 4 and of the irradiation zone 1 has been caused so as to preserve the relative position of the irradiation zone 1 on either side of the boundary F which further separates the defrosted zone 4a and still frozen zone 4b in the irradiated portion of the product 4.

In FIG. 12, the progression of the boundary F through the product 4 has been followed further, it then being situated in the middle part of the product 4.

In FIG. 13, the boundary F has almost reached the left end of the product 4, and only a reduced fringe 4b remains frozen. The whole of the remainder of the product 4 is defrosted. The displacement V′ will be continued until the irradiation zone 1 has entirely traversed the initially frozen product 4.

If FIG. 8 is considered again, the electromagnetic waves propagate, in the product 4, along the direction of its thickness e. The relative displacement between the irradiation zone 1 and the product 4 is performed along the direction of displacement V′. The irradiation zone is elongate along the direction of elongation II-II. It is seen that the aforesaid three directions are perpendicular to one another, in this embodiment.

The application of monomode electromagnetic waves makes it possible to concentrate in an irradiation zone 1 of width L2 of about 12 mm on either side of the direction of elongation II-II more than 60% of the energy of the electromagnetic waves applied to the product 4, thus concentrating the energy so as to optimize the conduction phenomenon on either side of the boundary F, between the defrosted zone 4a and the still frozen zone 4b of the product 4.

Thus, the heating process according to the invention is a hybrid heating process in which intrinsic heating by the electromagnetic waves collaborates with heating by conduction, in a permanent and controlled manner.

The result is a very appreciable increase in the speed of the thermal processing, at least in the defrosting step. With respect to a heating by microwaves without scanning, it is considered that the defrosting time according to the invention is reduced by 50%.

In practice, the prior processing by infrared further accelerates this process, by carrying out a surface processing of the product which at one and the same time generates a crust which is relatively leaktight and transparent to electromagnetic waves, with an already defrosted portion of product as a sub-layer below the crust. During the subsequent passage of the product through the irradiation zone, the electromagnetic waves are also absorbed by the defrosted portion of product in a sub-layer of the crust, thereby increasing the length of the boundary zone between the defrosted part and the still frozen product part, thus ensuring acceleration of the defrosting process.

It has thus been possible to achieve a very appreciable acceleration of the thermal processing of the product. By way of example, in fewer than 45 seconds, it has been possible to achieve correct cooking of hamburgers previously frozen to −18° C., with, in the final state, a surface crust of appropriate appearance and consistency, and with appropriate core cooking. The hamburgers which were the subject of this test initially had a weight of 113 grams, and a disk shape having a thickness of 12.5 millimeters. In the course of their processing according to the invention, they were arranged and displaced as illustrated in the figures.

The present invention is not limited to the embodiments which have been explicitly described, but it includes the diverse variants and generalizations thereof contained in the realm of the claims hereinafter.

1. Microwave heating method for the defrosting and thermal processing of a frozen product (4), comprising at least one step a) of defrosting in the course of which a portion of the product (4) is placed in an irradiation zone (1) subjected to an electromagnetic radiation and a relative displacement (7) of the irradiation zone (1) and of the product (4) with respect to one another is carried out in such a way that the irradiation zone (1) traverses the whole of the frozen product (4), wherein:
the relative displacement (7) of the irradiation zone (1) and of the product (4) with respect to one another is carried out at a speed and along a direction such that the irradiated portion of product (4) extends permanently, during said displacement, on either side of a boundary (F) between an already defrosted zone (4a) of irradiated portion of product and a still frozen adjacent zone (4b) of irradiated portion of product,
the electromagnetic radiation is monomode, formed from the superposition of opposite wave trains.

2. Microwave heating method for the defrosting and thermal processing of a frozen product (4) according to claim 1, further comprising a subsequent step b) of heating in the course of which the product (4) is irradiated by a monomode electromagnetic radiation by placing an irradiated portion of the product (4) in an irradiation zone (1) and by carrying out a relative displacement of the irradiation zone (1) and of the product (4) with respect to one another in such a way that the irradiation zone (1) traverses the whole of the product (4), until it brings the product (4) to a determined temperature.

3. Method according to claim 1, wherein the irradiation zone (1) exhibits an elongate form along a direction of elongation (II-II), wherein the relative displacement (7) is performed transversely with respect to the direction of elongation (II-II), and wherein the electromagnetic radiation propagates, in the irradiation zone (1), along a direction of propagation substantially perpendicular to the direction of elongation (II-II) and to the direction of the relative displacement (7).

4. Method according to claim 3, wherein:
the irradiation zone (1) exhibits, along the direction of elongation (II-II), a length (L1) substantially equal to a first corresponding dimension of the product to be processed (4),
the irradiation zone (1) exhibits, along the direction of displacement (7), a width (L2) that is less than its length (L1) and markedly less than the dimension of the product to be processed (4) in the direction of the relative displacement (7).

5. Method according to claim 3, wherein the direction of elongation (II-II) of the irradiation zone (1) is contained in a substantially vertical plane.

6. Method according to claim 1, wherein during the relative displacement of the irradiation zone (1) and of the product (4), the irradiation zone (1) is fixed and the product (4) is moving.

7. Method according to claim 1, wherein during the relative displacement of the irradiation zone (1) and of the product (4), the electromagnetic power injected is adapted to the size and to the dielectric properties of the irradiated portion of the product to be processed (4), so as to permanently ensure, in the irradiated portion, regulation of the volumic power, advantageously at a level substantially equal to or not very different from the volumic power absorbable by the irradiated portion of the product (4).

8. Method according to claim 7, wherein the regulation of the volumic power is performed by varying the speed of relative displacement between the irradiation zone (1) and the product (4) and/or by varying the global electromagnetic power injected.

9. Method according to claim 1, wherein prior to the defrosting step a), the product (4) is exposed to at least one infrared radiation (9).

10. Method according to claim 9, wherein prior to the defrosting step a), the product (4) is exposed to a short-wave infrared radiation and to a long-wave infrared radiation.

11. Method according to claim 9, wherein the infrared radiation or radiations (9) are applied to the product (4) in the neighborhood of the irradiation zone (1), resulting in an application of infrared by scanning which follows the relative displacement (7) of the product (4).

12. Method according to claim 9, wherein the infrared radiation or radiations (9) are applied simultaneously to the whole of the surface of the product (4).

13. Method according to claim 9, wherein an air current (10) is generated for drying the product (4) at the surface during its exposure to an infrared radiation (9).

14. Method according to claim 1, wherein the product (4) is maintained in position and in shape during its processing.

15. Microwave heating device for implementing the method according to claim 1, comprising:
radiation generating means (5, 6) for generating in at least one irradiation zone (1) a monomode electromagnetic radiation with wave trains propagating in opposite senses along a direction of propagation,
means for holding a product to be processed (2) for placing at least one irradiated portion of a product (4) in the irradiation zone (1),
displacement means (3) for ensuring the relative displacement of the irradiation zone (1) and of the product to be processed (4) along a transverse direction of displacement (7) with respect to the direction of propagation of the radiation, and at a speed appropriate for following the displacement of a boundary (F) between defrosted zone (4a) and still frozen zone (4b) of the product to be processed (4).

16. Device according to claim 15, wherein the irradiation zone (1) exhibits an elongate form along a direction of elongation (II-II), the displacement means (3) produce a relative displacement along a transverse direction of displacement (7) with respect to the direction of elongation (II-II), and the radiation generating means (5, 6) produce a monomode electromagnetic radiation with direction of propagation substantially perpendicular to the direction of elongation (II-II) and to the direction of displacement (7).

17. Device according to claim 16, wherein:
the irradiation zone (1) exhibits, along the direction of elongation (II-II), a length (L1) substantially equal to a first corresponding dimension of the product to be processed (4),
the irradiation zone (1) exhibits, along the direction of displacement (7), a width (L2) less than its length (L1) and less than the dimension of the product to be processed (4) in this same direction of displacement (7).

18. Device according to claim 15, wherein the displacement means (3) displace the product (4) with respect to the irradiation zone (1) which is fixed.

19. Device according to claim 15, comprising means (8) for regulating the volumic power injected into the product (4), so as preferably to inject a volumic power permanently substantially equal to or not very different from the volumic power absorbable by the product (4).

20. Device according to claim 19, wherein the means (8) for regulating the volumic power injected comprise means for controlling the global electromagnetic power and/or the speed of displacement of the product to be processed (4) with respect to the irradiation zone (1), so as to permanently adapt the global electromagnetic power and/or the speed as a function of the volume and dielectric properties of the irradiated portion of the product (4).

21. Device according to claim 15, comprising means for generating an infrared radiation (9) for applying an infrared radiation to the surface of the product (4) upstream of the irradiation zone or zones (1).

22. Device according to claim 21, successively comprising, upstream of the irradiation zone or zones (1), at least one shorter-wave infrared radiation lamp (9a, 9b), then at least one longer-wave infrared radiation lamp (9a, 9b).

23. Device according to claim 21, wherein the means for generating an infrared radiation (9) are arranged upstream and in the neighborhood of the irradiation zone (1).

24. Device according to claim 21, wherein the means for generating an infrared radiation (9) are designed to apply an infrared radiation simultaneously to the whole of the surface of the product (4).

25. Device according to claim 21, comprising means for sucking in (10) and/or circulating air for drying the product surface exposed to the infrared radiation.

26. Device according to claim 15, wherein the means for holding a product to be processed (2) comprise stainless steel elements (2a).

27. Device according to claim 15, wherein the means for holding a product to be processed (2) comprise quartz elements (2d) for maintaining the product (4) in shape and in place in the course of its processing in the irradiation zone (1).
